(19) United States
(12) Patent Application Publication
(10) Pub. No.: US 2002/0003711 A1
(43) Pub. Date: Jan. 10, 2002

(54) Displaying apparatus

(76) Inventors: Kiyofumi Hashimoto, Suita-Shi (JP); Keiko Momotani, Ibaraki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/880,437

(22) Filed: Jun. 13, 2001

(30) Foreign Application Priority Data
Jun. 16, 2000 (JP) 2000-181643

(51) Int. Cl. F21V 7/04

(52) U.S. Cl. 362/551; 362/31; 362/558; 362/559

(57) ABSTRACT

A displaying apparatus comprises a light-conducting body having first and second peripheral surfaces extending in the X and Y directions, respectively. A light source is provided adjacent to and along the second peripheral surface for emitting light through the second peripheral surface into the light-conducting body. A displaying element is opposed to the light-conducting body for performing display, using light projected from the light-conducting body toward the displaying element. The light-conducting body is formed with a curved region having first and second radii of curvature with respect to the X and Y directions, respectively. The first radius of curvature is equal to or greater than the second radius of curvature. The light source includes a plurality of separate light-emitters arranged along the Y direction.

### TECHNICAL FIELD

The present invention relates to a displaying apparatus that incorporates a light-conducting body for illuminating uniformly a display such as liquid crystal display.

### BACKGROUND OF THE INVENTION

Conventionally, there have been known displaying devices including a liquid crystal display (LCD), in which a light-conducting body is opposed to a major surface of the LCD for guiding light from a light source such as fluorescent tube toward the LCD to illuminate the LCD uniformly.

The light-conducting body has one peripheral surface through which light from the light source enters the body and a light-exit or major surface opposed to the LCD through which light exits toward the LCD.

The LCDs are available in transmissive and reflective versions.

The transmissive LCD holds the light-conducting body behind the LCD so that it is illuminated from the rear side of the LCD. This type of lighting system is referred to as a “back-lighting unit”.

The reflective LCD holds the light-conducting body in front of the LCD so that it is illuminated from the front side of the LCD. The reflective LCD displays typically by ambient light. However, when ambient light is insufficient, light is emitted as auxiliary illumination from the light source, transmitted though the light-conducting body and then projected toward the LCD. This type of lighting-system is referred as a “front-lighting unit”.

Such well-known displaying devices are typically in the form of a flat panel. In the meantime, displaying devices having a variety of configurations which may have curved portions have been recently demanded to meet design needs or space considerations. However, it has been discovered that, if a displaying device incorporates a light-conducting body having curved region(s), the amount of light from the light source that is not guided toward the LCD but is transmitted through the curved region(s) out of the light-conducting body is increased, which often results in an insufficient display brightness of the displaying device.

### SUMMARY OF THE INVENTION

Therefore, the object of the present invention is to provide a displaying device to provide sufficient display brightness in case where the light-conducting body is formed with curved region(s).

Accordingly, a displaying device includes a light-conducting body having a major surface, a first peripheral surface extending in a first direction, and a second peripheral surface extending in a second direction, the first and second directions crossing each other; a light source adjacent to and along the second peripheral surface of the light-conducting body for emitting light through the second peripheral surface into said light-conducting body; and a displaying element opposed to the major surface of the light-conducting body for displaying by light projected from the light-conducting body through the major surface toward the displaying element. The light-conducting body is formed with a curved region having first and second radii of curvature with respect to the first and second directions, respectively. The first radius of curvature is equal to or greater than the second radius of curvature.

The light source may include a plurality of separate light-emitters arranged along the second direction. Alternatively, the light source may include a flexible light-emitter such as organic electroluminescence element.

### BRIEF DESCRIPTION OF THE DRAWINGS

FIG. 1 is a perspective view of a first embodiment of the displaying device according to the present invention;

FIG. 2A is a cross-sectional view of the displaying device taken along the line IIa-IIa in FIG. 1;

FIG. 2B is a cross-sectional view of the displaying device taken along the line IIb-IIb in FIG. 1;

FIG. 3 is an enlarged partial cross-sectional view of the LCD in FIG. 1;

FIG. 4 is an enlarged partial cross-sectional view of the front surface of the light-conducting body in FIG. 2A;

FIG. 5 is a perspective view of a second embodiment of the displaying device according to the present invention;

FIG. 6A is a cross-sectional view of the displaying device taken along the line VIa-VIa in FIG. 5;

FIG. 6B is a cross-sectional view of the displaying device taken along the line VIb-VIb in FIG. 5;

FIG. 7 is an enlarged cross-sectional view of the light unit in FIGS. 5 and 6B;

FIG. 8 is a perspective view of a third embodiment of the displaying device according to the present invention; and

FIG. 9 is a perspective view of the displaying device according to the present invention in which a light unit is mounted behind the LCD.

### DETAILED DESCRIPTION OF THE PREFERRED EMBODIMENTS

With reference to the drawings, various embodiments of the displaying device according to the present invention will be described hereinafter. It should be noted that, although the present invention will be disclosed in connection with an LCD, another displaying element that requires illumination may be employed without departing from the scope of the invention.

I. First Embodiment

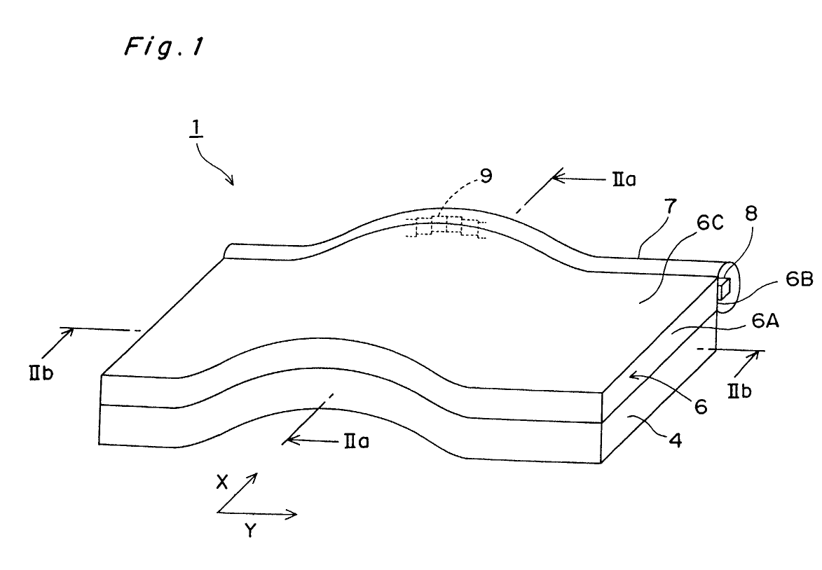

Referring to FIG. 1, a displaying device of the first embodiment according to the present invention, generally indicated by reference number 1, includes a front-lighting unit. The device 1 includes an LCD 4 and a light-conducting body 6 located in front of the LCD 4 for projecting light toward the LCD 4. Both the LCD 4 and light-conducting body 6 are in the form of a panel and bonded to each other so that at least a portion thereof is curved upwardly (i.e., toward a viewer) as shown in FIG. 1.

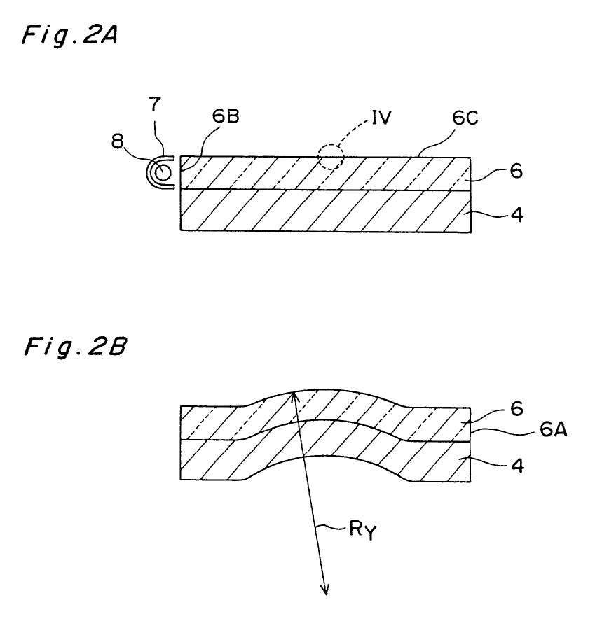

In this embodiment, the curved region of the LCD 4 and light-conducting body 6 takes a part-cylindrical configuration, as best seen in FIGS. 2A and 2B, showing cross-sectional views of the displaying device 1, taken along the first linear (X) direction, which is parallel to a first peripheral surface 6A of the light-conducting body 6 and taken along the second linear (Y) direction normal to the X direction, respectively. The term “part-cylindrical” is used herein to designate that the curved region takes its configuration that is generated by bending a plate with respect to a certain direction. In this embodiment, the curved region has a radius of curvature Ry (e.g., 100 m) in the Y direction smaller than the counterpart in the X direction (i.e., its curvature is zero.).

The displaying device 1 further includes a display controller not shown for controlling the LCD 4. A frame not shown houses the LCD 4, the light-conducting body 6 and the display controller so that the front surface 6C of the LCD 4 defines a display zone.

As shown in FIGS. 1 and 2A, a light source 8 is opposed to a second peripheral surface 6B extending in the Y direction of the light-conducting body 6. A reflector 7 is provided on the opposite side of the light source 8 with respect to the second peripheral surface 6B of the body 6. Accordingly, light emitted from the light source 8 enters the light-conducting body 6 through the second peripheral surface 6B. In this embodiment, as shown in FIG. 1, the light source 8 is composed of a plurality of separate light-emitters 9 such as LEDs arranged adjacent to and along the second curved peripheral surface 6B.

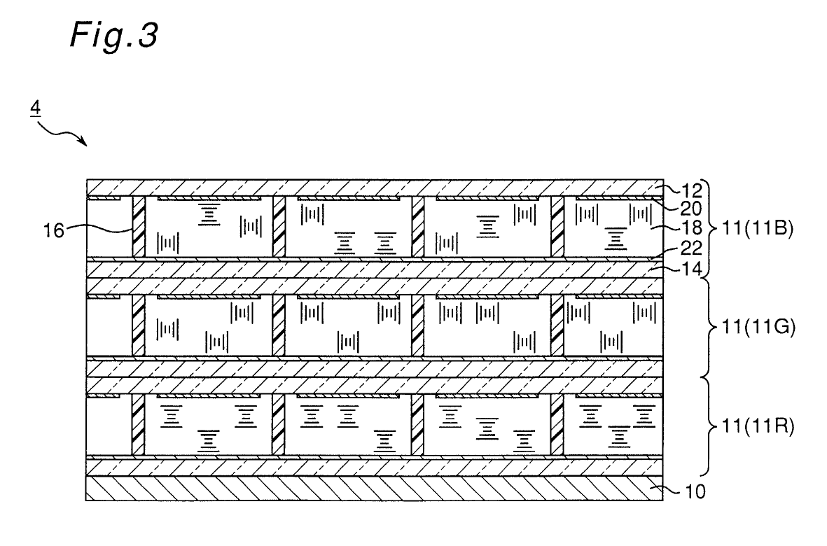

As shown in FIG. 3, the LCD 4 includes a light absorbing layer 10 and one or more displaying layers 11 provided on the light absorbing layer 4. In the embodiment shown, three displaying layers 11, i.e., red, green and blue displaying layers 11R, 11G, 11B are positioned one on top the other and are deposited in this order on the light absorbing layer 10. The displaying layers 11R, 11G, 11B have substantially identical structures.

More specifically, each displaying layer 11 includes a pair of transparent substrates, i.e., upper and lower substrates 12, 14, spaced apart from each other to form a predetermined gap therebetween. In each layer, the substrates 12, 14 are securely held by columns 16 extending in the thickness direction of the LCD 4. Preferably, the columns 16 are made of suitable resin. Each displaying layer 11 further includes liquid crystal (LC) 18 contained between the substrates 12, 14. Also, to maintain the gap constant, spacers not shown are provided between the substrates 12, 14, as known in the art.

A plurality of transparent electrodes, i.e., column electrodes 20 arranged parallel to the direction extending across the front and rear surfaces of the drawing of FIG. 3 are provided on the lower surface of the upper substrate 12. Likewise, a plurality of transparent electrodes, i.e., row electrodes 22 arranged laterally in FIG. 3 (i.e. perpendicular to the longitudinal direction of the column electrodes 20) are provided on the upper surface of the lower substrate 14. The column and row electrodes 20, 22 cross each other at right angles to define a matrix of pixels.

Note that, with respect to neighboring two displaying layers, an upper substrate of a displaying layer and an opposing lower substrate of the displaying layer immediately above may be replaced by one substrate, which reduces the number of the substrates and thereby provides a display of improved quality.

In this embodiment, the LC 18 of each displaying layer 11 is a cholesteric LC capable of selectively reflecting visible light. More specifically, the cholesteric LCs in the red, green and blue displaying layers 11R, 11G and 11B are capable of selectively reflecting red, green and blue light, respectively.

When a suitable voltage is applied to the electrodes 20, 22, the cholesteric LC between the electrodes 20, 22 is switched between a reflective state where the cholesteric LC reflects visible light that is within a spectral bandwidth centered about a predetermined wavelength and a transmissive state where the cholesteric LC transmits the visible light. Therefore, when the LC domains at a pixel defined by the specific column and row electrodes 12, 14 in a specific displaying layer are switched to the reflective state and white light such as natural light is projected toward the LC panel 4, the LC domains reflect visible light (e.g., red light), so that the corresponding color (e.g., red) is observed. On the other hand, when the LC domains at a pixel in a specific displaying layer are switched to the transmissive state, incident light is transmitted through the LC domains. Accordingly, by setting the LC domains at a pixel in a specific displaying layer 11 in the reflective state and at the same time by setting the LC domains at the same pixel in the other displaying layer(s) 11 located in front of the specific displaying layer 11 in the transmissive state, the color corresponding to the specific displaying layer 11 is observed at the pixel. Also, by setting all the LC domains at a pixel in the three displaying layers 11 in the transmissive state, incident light is absorbed in the light absorbing layer 10, so that black color is observed at the pixel.

As cholesteric LC in each displaying layer 11, a cholesteric LC that exhibits a cholesteric phase at room temperature or a nematic LC to which a chiral compound is added may be used. The cholesteric LC transforms to a “planar” state when it is applied with a relatively high-voltage pulse and to a “focal-conic” state by applying a relatively low-voltage pulse. When the cholesteric LC is applied with an intermediate voltage pulse, it transforms to an intermediate or “halftone color” state between the planar and the focal-conic states.

The cholesteric LC in the planar state reflects light that is within a spectral bandwidth centered about a wavelength λ=np, where n is the average refractive index of the LC and p is the pitch of a helical structure of the LC.

When the cholesteric LC reflects selectively light. in the infrared spectrum, the cholesteric LC in the focal-conic state scatters visible light. However, when the cholesteric LC reflects selectively light having a shorter wavelength, the cholesteric LC in the focal-conic state scatters less visible light so that it can be transmitted through the cholesteric LC.

When the cholesteric LC is in the intermediate state, the halftone color is displayed.

Thus, if the center wavelength is within a visible light spectrum and the LC 4 is provided with a back plate such as absorbing layer 10 that absorbs a transmitted radiation, the cholesteric LC can selectively be switched between the planar state where a specific color corresponding to the wavelength is displayed, the focal-conic state where black color is displayed, and the intermediate state where halftone color is displayed.

With the displaying device 1 so constructed, by switching the LC domains in each displaying layer 11 corresponding to a pixel between the transmissive or reflective states, the pixel displays red, green, blue, white, cyan, magenta, yellow and black. For example, if the LC domains at a pixel in the blue and green displaying layers 11B, 11G are in the focal-conic or transmissive state and the LC domains corresponding to the same pixel in the red displaying layer 11R are in the planar or reflective state, the pixel displays red color. If the LC domains at a pixel in the blue displaying layer 11B are in the focal-conic or transmissive state and the LC domains corresponding to the same pixel in the green and red displaying layer 11G, 11R are in the planar or reflective state, the pixel displays yellow color.

Also, if the LC domains at a pixel in one or more displaying layers 11 are in the intermediate state, the pixel displays any color.

As is well known to those in the art, these states, i.e., focal-conic, planar and intermediate states are maintained even if the voltage does not continue to be applied.

As described above, in this embodiment the light source 8 is mounted adjacent to the second peripheral surface 6B as shown in FIG. 2A, the amount of light is smaller that is not guided toward the LCD 4 and is directly transmitted out of the light-conducting body 6 through the front surface 6C thereof, in particular through the curved region, than in the case where the light source is mounted adjacent to the first peripheral surface 6A. That is, the arrangement of the embodiment is effective in directing light emitted from the light source 8 toward the LCD 4.

The light-conducting body 6 may be made of a transparent material such as acrylic resin, polycarbonate resin, amorphous polyolefin resin, a transparent inorganic material such as glass, or a combination material thereof.

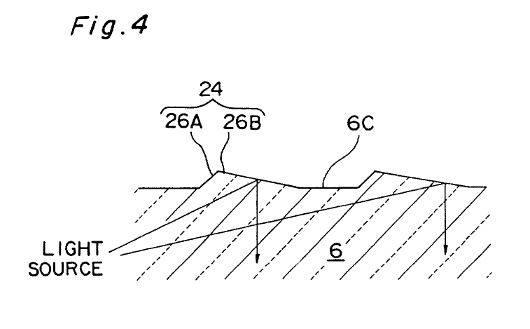

As shown in FIG. 4, the light-conducting body 6 preferably has a plurality of multifaceted microstructures (convex and concave portions) 24 disposed along the front surface 6C so that light emitted from the light source 8 is reflected with high efficiency by the front surface 6C to travel toward the LCD 4. The microstructures 24 are arranged to form columns of facets 26A, 26B which run along the Y direction.

Note that light may also be guided into the light-conducting body 6 through the peripheral surface thereof opposite the peripheral surface 6B. In this case, the facets 26A, 26B preferably have the same length with respect to FIG. 4.

The angle between the facets 26A, 26B and/or the pitch of the microstructures 24 may be changed with distance of the microstructures 24 from the first peripheral surface 6A of the light-conducting body 6, which is more effective in preventing light from the light source 8 from directly transmitting through the curved region of the front surface 6C. Alternatively or in addition, a coating with relatively high refractive index may be provided on the front surface 6C of the light-conducting body 6.

In case where the substrates 12, 14 are made of a resin film (therefore, the LCD 4 is flexible.) and the light-conducting body 6 bonded to the LCD 4 is flexible, it is possible to form a desired curvature of the LCD 4 and the light-conducting body 6. In this embodiment, since the light source 8 is comprised of a plurality of separate light-emitters, the light source can easily be arranged with a great degree of accuracy adjacent to and along the curved peripheral surface 6B of the light-conducting body 6.

In this embodiment, the light-conducting body 6 has a part-cylindrically curved body. Therefore, with respect to the X direction (FIG. 1) in which the light-conducting body 6 is extended substantially linearly, light energy of the light source 8 can be used effectively without substantial loss in the X direction due to the light-conducting body 6 being formed with the curved region.

Noted that, although in the present embodiment the LCD with three displaying layers is described, an LCD with one or more displaying layers is included within the scope of the present invention.

Also, the curvature of the curved peripheral surface 8B of the light-conducting body 6 may not be constant.

Further, although in the present embodiment the light-conducting body 6 is formed in part with a curved region, the entire portion of the light-conducting body may take a part-cylindrically curved configuration that is generated by bending a plate with respect to a direction.

In addition, although in the present invention the curved region of the light-conducting body 6 is convexed in a thickness direction of the body 6, it may be concaved.

II. Second Embodiment

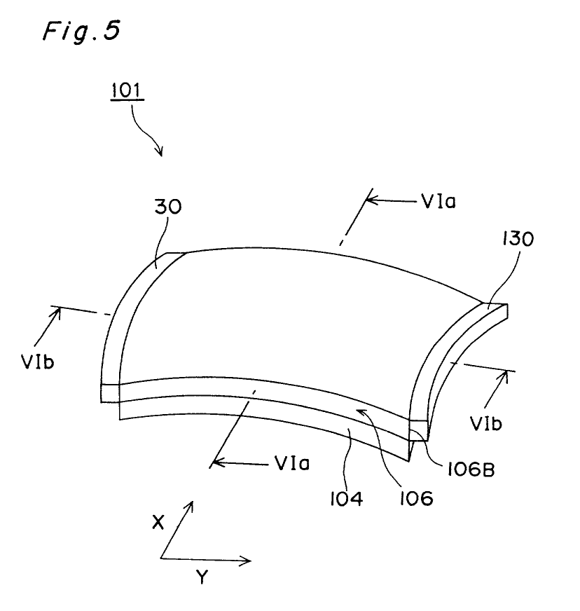

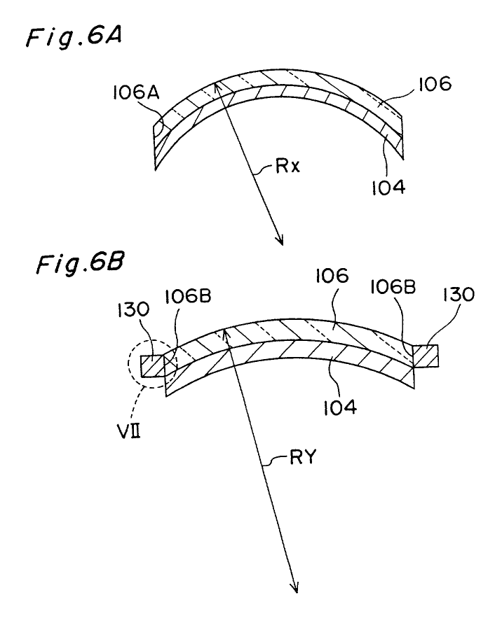

FIG. 5 shows a perspective view of a second embodiment of the displaying device according to the present invention. FIG. 6A shows a cross-sectional view of the displaying device 101, taken along the first linear (X) direction, which is parallel to a second peripheral surface 106B of the light-conducting body 106. FIG. 6B shows a cross-sectional view of the displaying device 101, taken along the second linear (Y) direction normal to the X direction. As shown in the drawings, the entire light-conducting body 106 and LCD 104 are curved three-dimensionally. This means that the curved region takes its configuration that is generated by bending a plate in a certain direction and another direction normal to the certain direction. In this embodiment, the curved members 104, 106 have a radius of curvature Ry (e.g., 300 m) in the Y direction greater than the counterpart Rx (e.g., 100 m) in the X direction.

As shown in FIGS. 5 and 6B, a pair of light units 130 is mounted adjacent to the peripheral surfaces 106B curved in the X direction of the light-conducting body 106. In this embodiment, each light unit 130 includes an organic electroluminescence (EL) element or flexible light-emitter as light source.

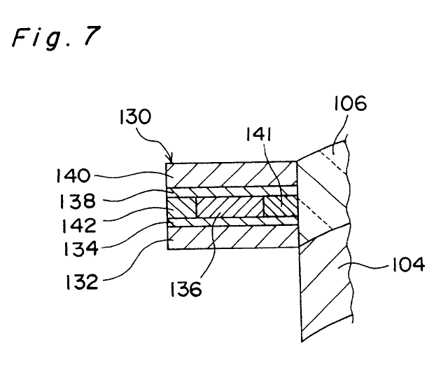

Specifically, as shown in FIG. 7, the EL element of the light unit 130 includes a thin film electrode 134, an organic luminescent layer 136, a thin film electrode 138, and a resin coating layer 140 deposited in this order on a resin film 132. The light unit 130 also includes a drive circuit not shown for applying a voltage to the electrodes 134, 138 to cause radiation from the organic luminescent layer 136.

One end of the organic luminescent layer 136 is located adjacent to a flexible transparent member 141, which is opposed to the second peripheral surface 106B of the light-conducting body 106 so that light emitted from the layer 136 enters the light-conducting body 106 through the transparent member 141. A flexible member 142 is also mounted with a reflective coating on its surface opposed to the other end of the organic luminescent layer 36.

The EL element so constructed is flexible. Therefore, the light source or EL element can be curved along the peripheral surface 106B of the light-conducting body 106.

As described above, in this embodiment the “three-dimensional” light-conducting body is used. The light source is positioned adjacent to and along the peripheral surface 106B extending in the X direction, the radius of curvature of which is greater than that of the peripheral surface 106A extending in the Y direction. Accordingly, the amount of light that is not guided toward the LCD but is directly transmitted through the front surface of the light-conducting body can be minimized.

III. Third Embodiment

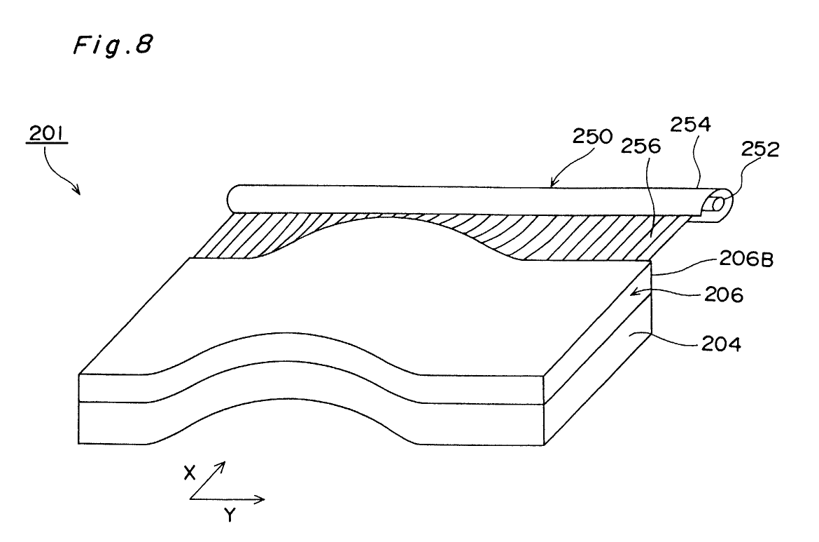

FIG. 8 shows a perspective view of a third embodiment of the displaying device according to the present invention. Like the displaying device 1 shown in FIG. 1, the displaying device 201 has a part-cylindrically curved region of the LCD 204 and light-conducting body 206. However, the configuration of the light unit 250 for guiding light into the light-conducting body 206 in the displaying device 201 is different from that of the displaying device 1.

Specifically, the light unit 250 includes a light source or cold cathode tube 252 spaced apart from the curved second peripheral surface 6B of the light-conducting body 206. A reflector 254 is provided on the opposite side of the light source 252 with respect to the second peripheral surface 206B. A bundle of optical fibers 256 is also provided as waveguide for guiding light emitted from light source 252 to the second peripheral surface 206B of the light-conducting body 206.

In this embodiment, as light source 252, a non-flexible cold cathode tube extending generally linearly is used. However, the optical fiber bundle 256 is used to optically connect the curved peripheral surface 206B to the light source 252 so that light from the light source 252 is guided through the bundle 256 to the curved peripheral surface 206B of the light-conducting body 206.

Thus, a suitable waveguide is used to provide an optical connection between the light source and light-conducting body, so that, if the configuration of the light source and light-conducting body does not match each other, light emitted from the light source can be accurately directed into the light-conducting body.

IV. Others

Although in the previous embodiments a reflective LC capable of selectively reflecting light is used, a transmissive LC may be used and then the light absorbing layer is replaced by a reflecting plate on the back of the LCD so that the displaying device displays using light from its front side.

Also, although in the previous embodiments the light-conducting body is provided on the front side of the LCD, the present invention is applicable to a back-lighting unit in which a light unit that includes a light-conducting body and a light source positioned adjacent to and along a peripheral surface of the light-conducting body may be provided on the back side (which is remote from the observer) of the LCD.

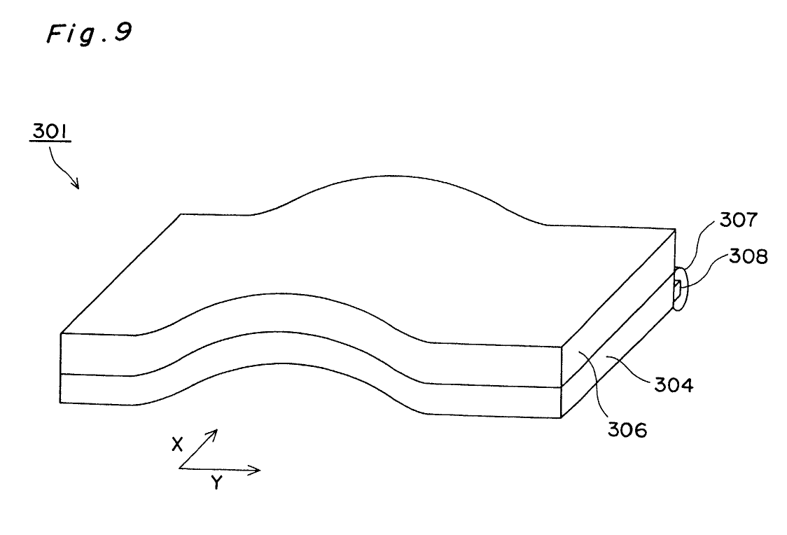

FIG. 9 shows an example of a displaying device 301 in which the light-conducting body 304 is provided on the back of the LCD 306. The LCD 306 includes a transmissive LC such as TFT LC.

Further, although in the previous embodiments the LCD and light-conducting body are curved toward the observer, they may be curved away from the observer.

Furthermore, although in the previous embodiments the first and second peripheral surfaces cross at right angles, these peripheral surfaces may cross at any obtuse or acute angle without departing from the scope of the present invention.

According to the present invention, the light source is located along the peripheral surface of the light-conducting body extending in a first direction. The curved region of the light-conducting body is configured so that its radius of curvature in the first direction is equal to or smaller than the counterpart in a second direction. For example, where the light-conducting body is part-cylindrical, light is guided into the light-conducting body through the curved peripheral surface. Therefore, the amount of light that is not guided toward the display but is directly transmitted through the curved region can be minimized, which creates a high brightness display.

In particular, according to the present invention, bright images can be presented in the displaying devices in which the display is performed using selective reflection of light by the cholesteric phase of the LC or in which more than one displaying layers are positioned on top the other.

Also, according to the present invention, as a light source opposed to the curved peripheral surface of the light-conducting body, a plurality of separate light-emitters or a flexible light-emitter is used. Alternatively, a light source is optically connected through a waveguide to the curved peripheral surface of the light-conducting body. Therefore, the light-conducting body can be shaped in any curved form, which is advantageous for designing and/or mounting. Further, when a flexible light-conducting body (in particular, the display element is also flexible.), the configuration of the light source or waveguide can be adjusted easily according to the curvature of the light-conducting body and display element, so that a desired illumination can always be realized.

What is claimed is:

1. A displaying apparatus comprising:
a light-conducting body having a major surface, a first peripheral surface extending in a first direction, and a second peripheral surface extending in a second direction, said first and second directions crossing each other;
a light source adjacent to and along said second peripheral surface of said light-conducting body for emitting light through said second peripheral surface into said light-conducting body; and
a displaying element opposed to said major surface of said light-conducting body for displaying by light projected from said light-conducting body through said major surface toward said displaying element;
wherein said light-conducting body is formed with a curved region having first and second radii of curvature with respect to said first and second directions, respectively, said first radius of curvature being equal to or greater than said second radius of curvature; and
wherein said light source includes a plurality of separate light-emitters arranged along said second direction.

2. A displaying apparatus comprising:
a light-conducting body having a major surface, a first peripheral surface extending in a first direction, and a second peripheral surface extending in a second direction, said first and second directions crossing each other;
a light source adjacent to and along said second peripheral surface of said light-conducting body for emitting light through said second peripheral surface into said light-conducting body; and
a displaying element opposed to said major surface of said light-conducting body for displaying by light projected from said light-conducting body through said major surface toward said displaying element;
wherein said light-conducting body is formed with a curved region having first and second radii of curvature with respect to said first and second directions, respectively, said first radius of curvature being equal to or greater than said second radius of curvature; and
wherein said light source includes a flexible light-emitter.

3. A displaying apparatus in accordance with claim 2 wherein said flexible light-emitter is an organic electroluminescence element.

4. A displaying apparatus comprising:
a light-conducting body having a major surface, a first peripheral surface extending in a first direction, and a second peripheral surface extending in a second direction, said first and second directions crossing each other;
a light source spaced apart from said second peripheral surface of said light-conducting body;
a waveguide for optically connecting said light source to said second peripheral surface of said light-conducting body; and
a displaying element opposed to said major surface of said light-conducting body for displaying by light projected from said light-conducting body through said major surface toward said displaying element;
wherein said light-conducting body is formed with a curved region having first and second radii of curvature with respect to said first and second directions, respectively, said first radius of curvature being equal to or greater than said second radius of curvature.

5. A displaying apparatus in accordance with claim 4 wherein said waveguide is flexible.

6. A displaying apparatus comprising:
a light-conducting body having a front surface, a rear surface, a first peripheral surface extending in a first direction, and a second peripheral surface extending in a second direction, said first and second directions crossing each other;
a light source opposed to said second peripheral surface of said light-conducting body for emitting light through said second peripheral surface into said light-conducting body; and
an LCD which has first and second substrates spaced apart from each other to define a gap therebetween and a liquid crystal filled in said gap, said first substrates being opposed to said rear surface of said light-conducting body;
wherein said LCD displays using light projected from said light-conducting body through said rear surface toward said LCD;
wherein said light-conducting body is formed with a curved region having first and second radii of curvature with respect to said first and second directions, respectively, said first radius of curvature being equal to or greater than said second radius of curvature; and
wherein said LCD displays using selective reflection of light by a cholesteric phase of said liquid crystal.

7. A displaying apparatus in accordance with claim 6 wherein said substrates of said LCD are flexible.

8. A displaying apparatus in accordance with claim 7, wherein said light-conducting body and LCD are superimposed on top the other so that said rear surface of said light-conducting body opposes said first substrate of said LCD.

9. A displaying apparatus comprising:
a light-conducting body having a major surface, a first peripheral surface extending in a first direction, and a second peripheral surface extending in a second direction, said first and second directions crossing each other;
a light source opposed to said second peripheral surface of said light-conducting body for emitting light through said second peripheral surface into said light-conducting body; and
an LCD including
a first displaying layer which has a first surface and a second surface opposed to said first surface; and
a second displaying layer which has a third surface and a fourth surface opposed to said third surface, said second displaying layer being positioned so that said third surface opposes said second surface of said first displaying layer;
wherein each of said first and second displaying layers having first and second substrates spaced apart from each other to define a gap therebetween and a liquid crystal filled in said gap;
wherein said LCD is opposed to said major surface of said light-conducting body so that the display is performed using light projected from said light-conducting body through said major surface toward said LCD; and
wherein said light-conducting body is formed with a curved region having first and second radii of curvature with respect to said first and second directions, respectively, said first radius of curvature being equal to or greater than said second radius of curvature.

10. A displaying apparatus comprising:
a light-conducting substrate in the form of plate, said substrate being curved in whole or in part to define a straight first peripheral surface extending in a first direction and a curved second peripheral surface extending in a second direction, said first and second directions crossing each other;
a light source adjacent to and along said curved peripheral surface of said light-conducting body for emitting light through said curved peripheral surface into said light-conducting body; and
a displaying element opposed to a major surface of said light-conducting body for displaying by light projected from said light-conducting body through said major surface toward said displaying element.
